(19) United States
(12) Patent Application Publication
(10) Pub. No.: US 2013/0297588 A1
(43) Pub. Date: Nov. 7, 2013

(54) Flexible Dashboard Enhancing Visualization of Database Information

(71) Applicant: Harish Tyagi, Palo Alto, CA (US)

(72) Inventor: Harish Tyagi, Palo Alto, CA (US)

(73) Assignee: SAP AG, Walldorf (DE)

(21) Appl. No.: 13/465,350

(22) Filed: May 7, 2012

(51) Int. Cl. G06F 17/30

(52) U.S. Cl. 707/722; 707/E17.014

(57) ABSTRACT

Embodiments provide systems and methods allowing optimization of dashboard analytics. In certain embodiments, results obtained from querying a database may be manipulated to arrange, replace, or supplement existing views. The end user is afforded control to drag and drop view(s) for positioning within a dashboard, as well as to provide additional and/or replacement views. The dashboard can serve as one point of contact allowing end users to render reports created in business warehouse systems, or business intelligence on-demand systems.

### BACKGROUND

The present invention relates to computing, and in particular, to a systems and methods for displaying information to a user.

Unless otherwise indicated herein, the approaches described in this section are not prior art to the claims in this application and are not admitted to be prior art by inclusion in this section.

Data stored in data warehouses may be interrogated by a user formulating a query, and then posing that query to the data warehouse. A corresponding query result is then returned for the user's inspection.

Typically, the result of database querying is communicated to the user via a display that includes one or more views of different types (e.g. pie chart, bar chart). That display environment is also referred to herein as a dashboard.

As the volume and complexity of data stored in data warehouses continues to increase, exploration of that data for analytical purposes becomes more complex. However, current dashboards tend to be rather inflexible, in that they return query results in a limited number of views having pre-determined relationships with one another.

Accordingly there exists a need for tools facilitating user visualization of database information in a flexible manner that promotes detailed analysis. The present disclosure addresses these and other issues with systems and methods for optimizing a dashboard for display of analytical information.

### SUMMARY

Embodiments provide systems and methods allowing optimization of dashboard analytics. In certain embodiments, results obtained from querying a database may be manipulated to arrange, replace, or supplement existing views of a dashboard. The end user is afforded control to drag and drop view(s) for positioning within the dashboard, as well as to provide additional and/or replacement views. The dashboard can serve as one point of contact allowing end users to render reports created in business warehouse systems, or business intelligence on-demand systems.

An embodiment of a computer-implemented method comprises causing a view engine to display to a user on a screen, a dashboard comprising a view of a database query result. The view engine is caused to receive an input from a user. In response to the input, the view engine is caused to create a modified dashboard. The view engine is caused to display to the user, the modified dashboard.

An embodiment of a non-transitory computer readable storage medium embodies a computer program for performing a method comprising, causing a view engine to display to a user on a screen, a dashboard comprising a view of a database query result. The view engine is caused to receive an input from a user. In response to the input, the view engine is caused to create a modified dashboard. The view engine is caused to display to the user, the modified dashboard.

An embodiment of a computer system comprises one or more processors and a software program, executable on said computer system. The software program is configured to cause a view engine to display to a user on a screen, a dashboard comprising a view of a database query result. The view engine is caused to receive an input from a user. In response to the input, cause the view engine is caused to create a modified dashboard. The view engine is caused to display to the user, the modified dashboard.

According to some embodiments, the user input comprises a click and drag of the view, and the modified dashboard comprises a change in location of the view on the screen.

In certain embodiments, the user input comprises selecting a different view of the database query result, and the modified dashboard comprises the different view.

In particular embodiments, the different view comprises a different view format including query result information already present in the view.

According to certain embodiments, selecting the different view comprises selecting the different view from a list of available views.

Some embodiments further comprise causing the view engine to communicate with a query engine to retrieve the different view.

In certain embodiments, the different view comprises a new view type, and the method further comprises causing the view engine to communicate to a query engine, a parameter of the new view type.

The following detailed description and accompanying drawings provide a better understanding of the nature and advantages of the present invention.

### BRIEF DESCRIPTION OF THE DRAWINGS

FIG. 1 shows a simplified view of a computer system according to an embodiment.

FIGS. 2-2BC show various configurations of a dashboard embodiment according to an example.

FIG. 3 illustrates hardware of a special purpose computing machine configured to provide a dashboard according to an embodiment.

FIG. 4 shows a computer system according to an embodiment.

### DETAILED DESCRIPTION

Described herein are techniques for enhancing visualization of database information. The apparatuses, methods, and techniques described below may be implemented as a computer program (software) executing on one or more computers. The computer program may further be stored on a computer readable medium. The computer readable medium may include instructions for performing the processes described below.

In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

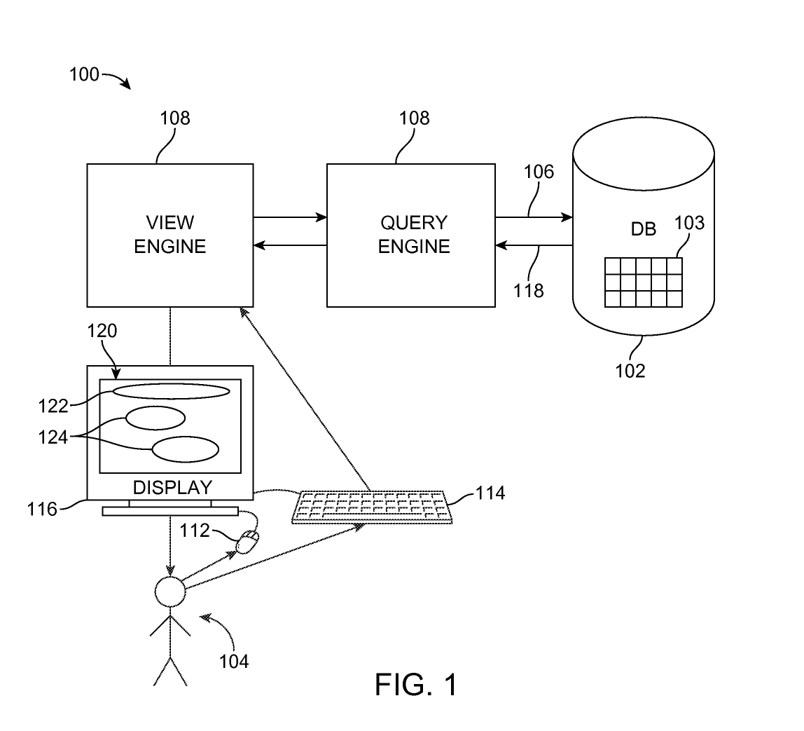

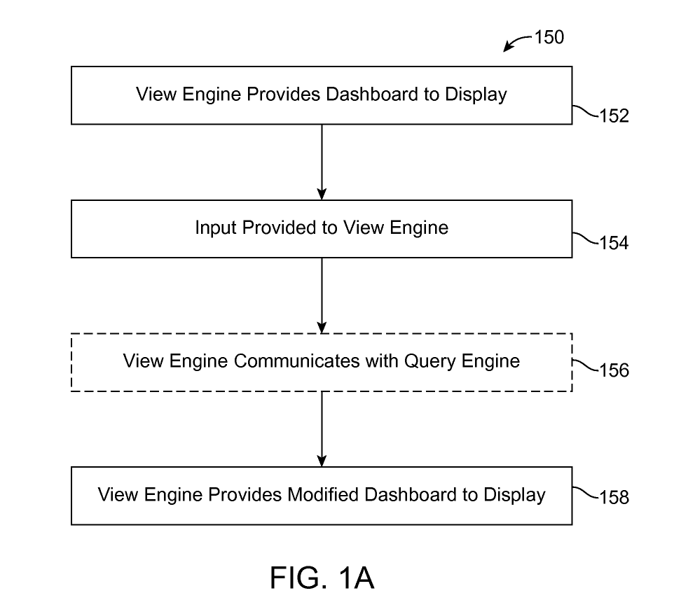

FIG. 1 illustrates one example of a computer system according to an embodiment. Computer system 100 comprises a database 102 having data 103 stored therein. In certain embodiments the database may comprise a part of a business warehouse system or business intelligence on-demand system, such as an Enterprise Resource Planning (ERP) system.

A user 104 is configured to interact with information present within the database by posing queries 106 thereto. The queries may be formulated by the user interacting with a query engine 108 through a view engine 110 and input/output devices such as a mouse 112 and keyboard 114, and a display device 116.

Query results 118 are then returned to the user via the query engine and the view engine. In particular, the view engine provides to the display, a dashboard 120 comprising a menu bar 122 and one or more views 124 allowing visualization of relevant data returned from the database in query response.

Embodiments as described herein relate to methods and systems allowing a user to manipulate a dashboard to arrange, replace, or supplement existing views. The end user may be afforded control to drag and drop view(s) for positioning within the dashboard, as well as to provide additional and/or replacement views. The dashboard can serve as one point of contact allowing end users to render reports created in business warehouse systems, or business intelligence on-demand systems.

FIG. 1A is a simplified chart showing a method 150 according to one embodiment. In a first step 152 a view engine provides to a display, a dashboard comprising at least one view of a query result.

In a second step 154, a user provides an input to the view engine to modify the dashboard. According to certain embodiments, this input could be in the form of a click and drag action by a mouse to change a location of a view within the dashboard. As described in detail below, this input could alternatively be to change a view format. As also described in detail below, this input could be to select an alternative/additional view from a list of choices.

In an optional third step 156, the view engine may communicate with the query engine to obtain relevant additional information. For example, in certain embodiments the user input to the view engine may request the dashboard to display a view type calling for query result information that is not already present in an existing view. Hence, this additional query result information are retrieved from the query engine.

Moreover, according to some embodiments, the user input to the view engine may request the dashboard to display a new view type that must be created by the query engine from data returned from the database. Accordingly, the parameters of this new view type are communicated to the query engine.

Under certain circumstances, the view engine may not need to communicate with the query engine in response to a user input. One such circumstance is where the user input seeks merely to rearrange the position of existing views within the dashboard, with no additional information being called for.

Another such circumstance is where the user input seeks merely to switch from one view format to another (e.g. from horizontal bar chart to vertical bar chart, from bar chart to graphical plot, etc.), without requiring additional information from the query result. This is further discussed in connection with the Example given below.

In a fourth step 158, the view engine provides a modified dashboard to the display in response to the user input. This output could be to rearrange the existing views of the dashboard. Alternatively or in conjunction with such rearrangement, this output could be to substitute an existing view or view type, with a different one.

The following example describes a series of screen shots of a dashboard according to an embodiment. In particular, this example relates to a dashboard displaying results of querying a data warehouse that contains sales information.

### EXAMPLE

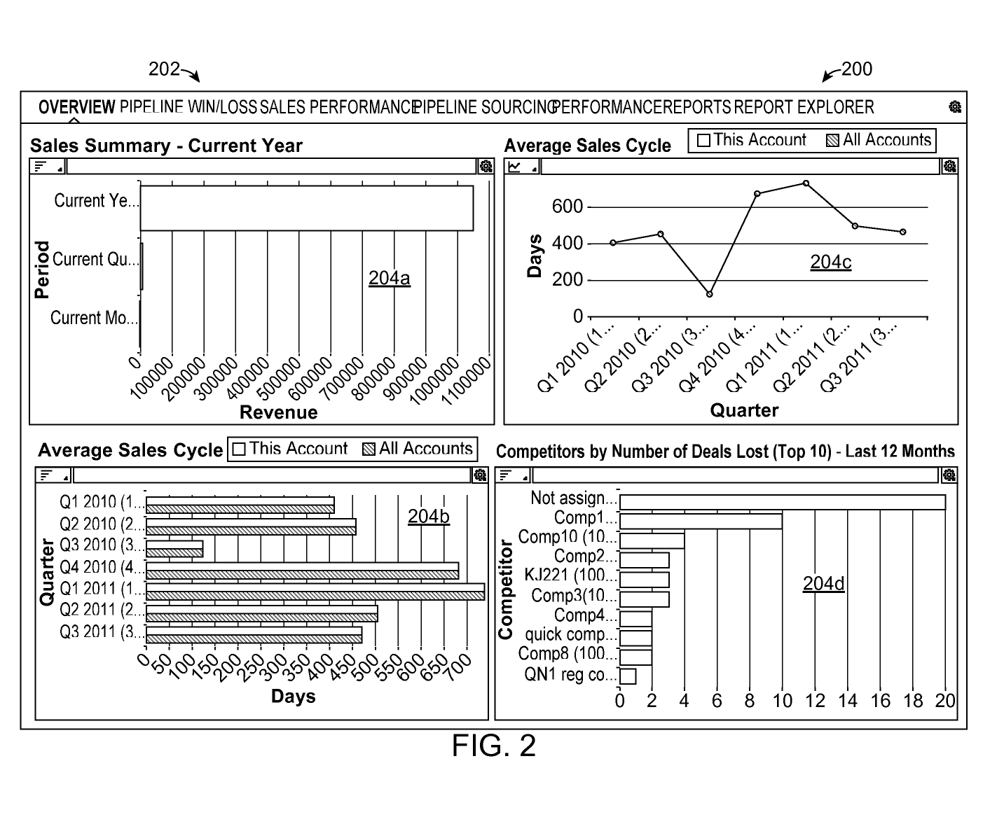

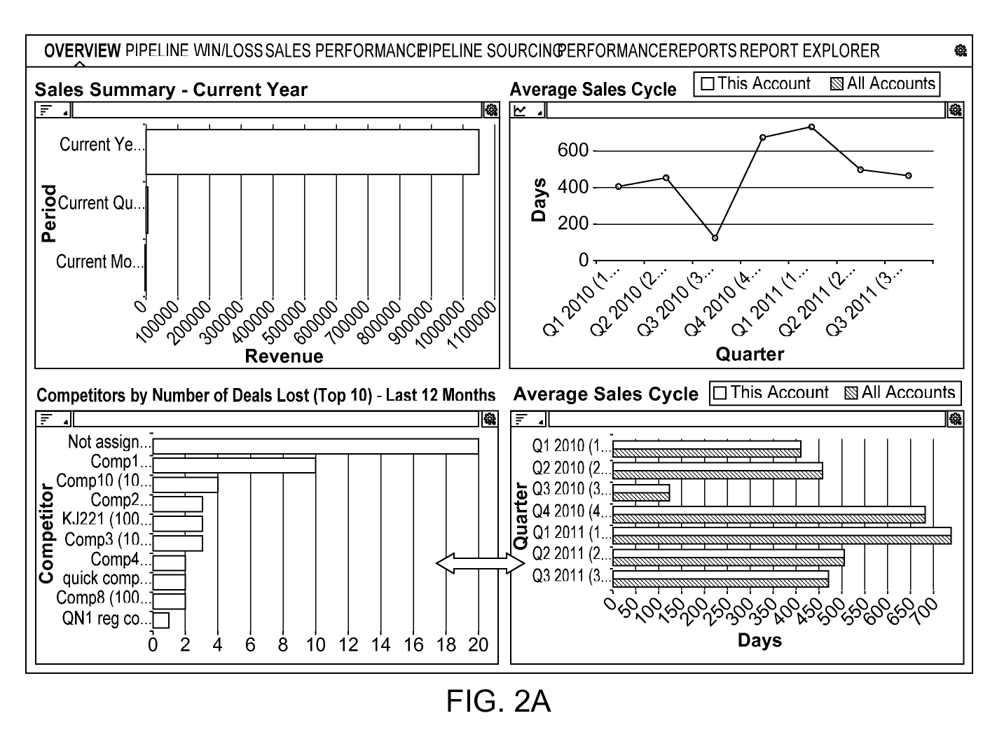

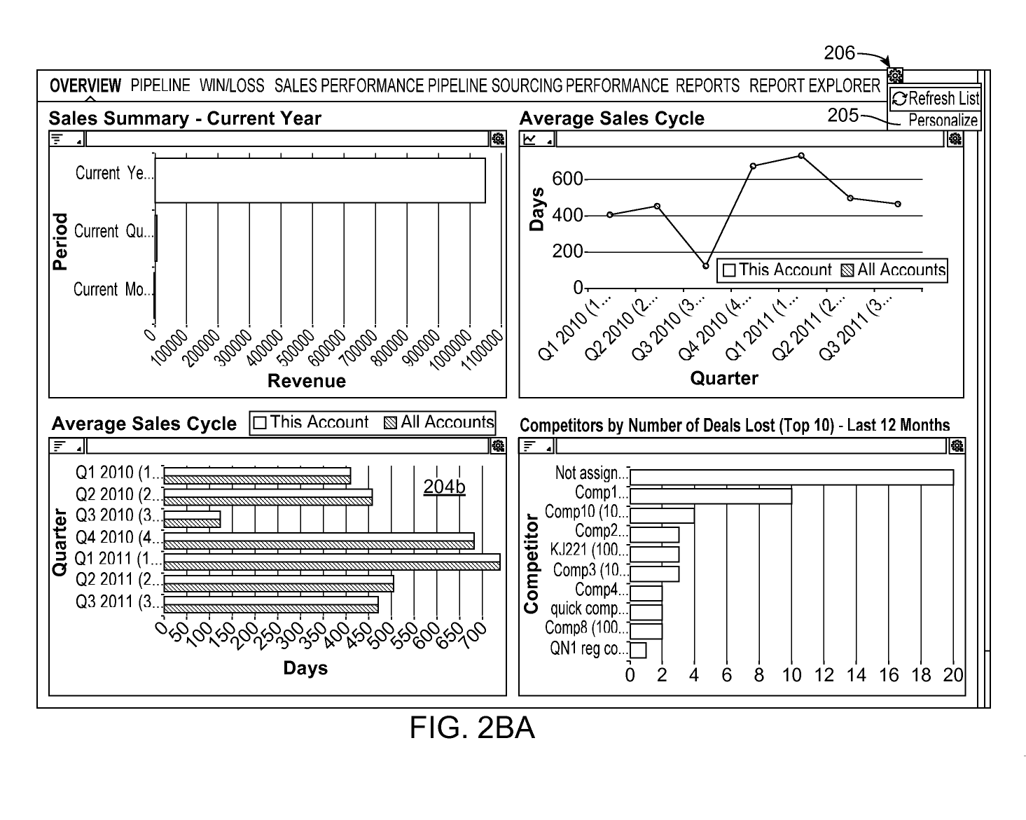

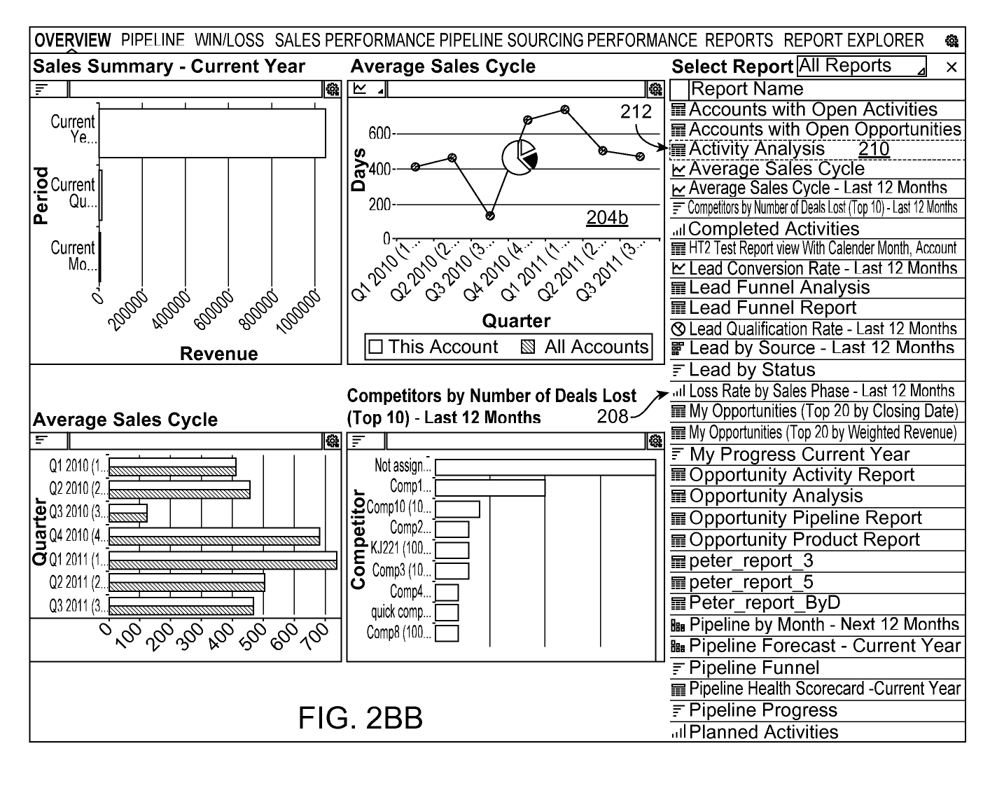

FIGS. 2-2BC show various configurations of an example of a dashboard according to an embodiment. In particular, FIG. 2 shows an existing dashboard 200 returning query results from a data warehouse comprising sales information.

Dashboard 200 comprises a menu bar 202 and a plurality (here four) of views 204a-b. A first view 204a positioned in the upper left quadrant comprises a “Sales Summary” in the form of a (horizontal) bar chart, showing revenue over particular time periods (year, quarter, month).

Two of the other views of the dashboard present the same information from the query result in a different manner. Specifically, the second view 204b of the lower left quadrant of the dashboard comprises an “Average Sales Cycle” in the format of a (horizontal) bar chart comparing an instant account with all accounts. The third view 204c of the upper right quadrant of the dashboard also comprises an “Average Sales Cycle” in the format of a graphical plot, showing days per quarter. It is noted that in this particular dashboard, the data from “This Account” and “All Accounts” are the same. Thus the corresponding graphical plots in the view 204c are coincident and completely overlap so that only one is visible.

Finally, the last view 204d of the existing dashboard 204 shows still other information contained in the data warehouse that is relevant to the query result. In particular, view 204d located in the lower right quadrant of the dashboard shows “Competitors by Number of Deals Lost”, in the form of a (horizontal) bar chart.

FIG. 2A shows one aspect of this embodiment, wherein the physical location of the various views 204a-d within the existing dashboard, may be rearranged by the user. In particular, the user may drag and drop the views up, down, diagonally, or in any manner to accomplish a desired orientation.

For example in this particular embodiment, it may be desired to vertically align views of similar information (e.g. views 204b, 204c) so as to facilitate their visual comparison and allow the user to rapidly gain additional insight therefrom. The location of the views can thus be shifted by the user in the manner indicated by the arrow. While not necessary in this particular case, the remaining views of the dashboard could also be moved by the user in order to ensure their continued visibility.

In certain embodiments a change in the location of views in a dashboard, may be accomplished by a view engine accessing available information, without recourse to the query engine. This can result in faster operation.

FIGS. 2BA-BC show another aspect according to this embodiment, wherein the dashboard may be modified to replace an existing view with another. In particular, FIG. 2BA shows the user selecting a tool icon 206 (here a gear symbol) in the menu bar, resulting in the display of an option 205 to personalize the dashboard.

FIG. 2BB shows that upon selection of this personalization option, the user may click upon a view to be replaced (here the “Average Sales Cycle” plot 204c), and then be presented with a listing 208 of other views that are available. These available views may be determined based upon returned database information according to the particular parameters of the original query. Here, in FIG. 2BB the listing includes the option 210 to select the view “Activity Analysis”.

While FIG. 2BB presents a listing of available view types, according to certain embodiments the user may be presented with the opportunity to select a new view type for display in the dashboard. For example, while the listing 208 does offer the user the option of selecting a view corresponding to “Accounts with Open Activities”, the listing does not offer the user the option of selecting a view corresponding to “Accounts with Closed Activities”. Listing 208 may thus include an option for the user to select a new view type, and then to communicate with query engine via the view engine to determine the parameters of that new view type.

In FIG. 2BB, the format of a particular view is also indicated as an icon 212 in the listing. Examples of such view formats include but are not limited to continuous bar charts (of horizontal or vertical orientation), segmented bar charts (of horizontal or vertical orientation), pie charts, plots, or tables.

Certain such a view formats may be characterized by displaying the same information in a different manner. Examples can include horizontal and vertical bar charts, and bar charts and graphic plots.

The figures further show that the appropriate icon also forms a part of the view itself. FIG. 2BC thus shows that upon user selection of the table view “Activity Analysis”, that new view 204e replaces the “Average Sales Cycle” plot view formerly located in the upper right hand quadrant of the dashboard. This view 204e includes a table icon 214 to indicate its format.

According to certain embodiments, the view format icon present in a particular view of the dashboard, may offer the user the ability to move between available view formats. Thus by clicking on the icon 216 for example, the user could be offered a menu to change the format of view 204b from a horizontal bar chart to a graphical plot or to a vertical bar chart.

In certain embodiments a change in the dashboard between view types, may be accomplished by a view engine accessing available information, without recourse to the query engine. This can result in faster operation.

In the particular embodiment of FIG. 2BB, the pie chart icon serves to generically indicate that the selected report is in dragging mode and able to be moved for full display on the dashboard.

While the above example presents a dashboard according to a particular embodiment that is capable of displaying four different views in a quadrangle orientation, this is not required. Alternative dashboard embodiments could be configured to display a smaller or greater number of views, arranged in a different orientation (e.g. circular, triangular, staggered, irregular/overlapping).

Moreover the particular types of views and view formats that are available, are not limited to those of this specific example. Other views could certainly be presented in a dashboard. Possible view types include but are not limited to, animations, three-dimensional depictions, Sankey diagrams, pie charts, bar charts, columns, lines, rows, tables, areas, stacked bars, stacked columns, stacked areas, and stacked lines.

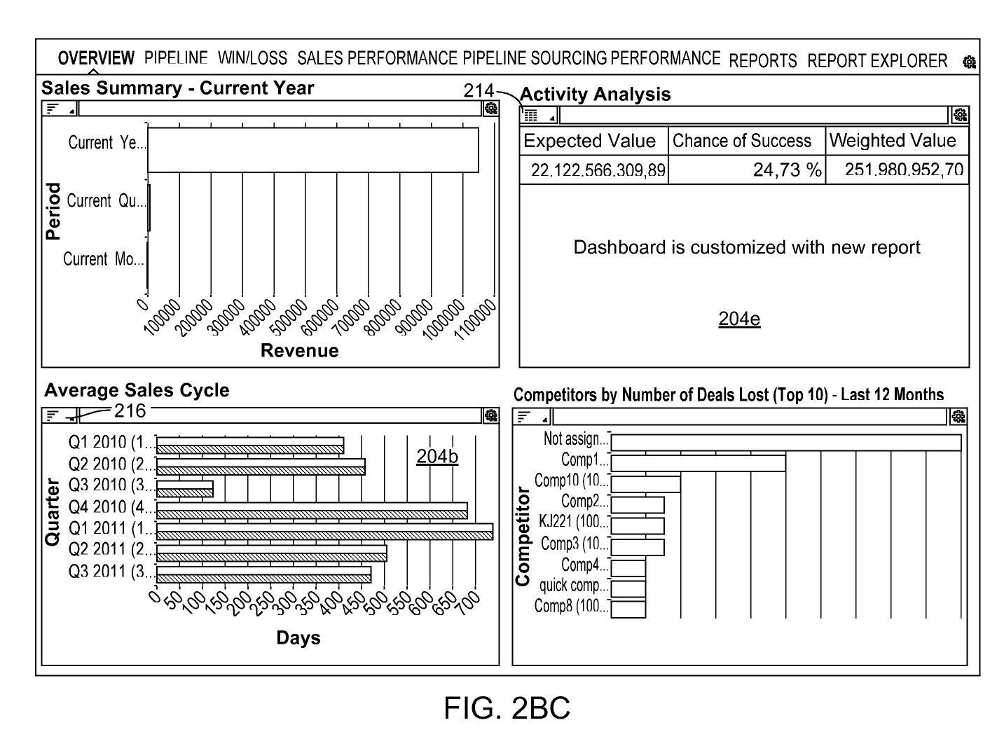

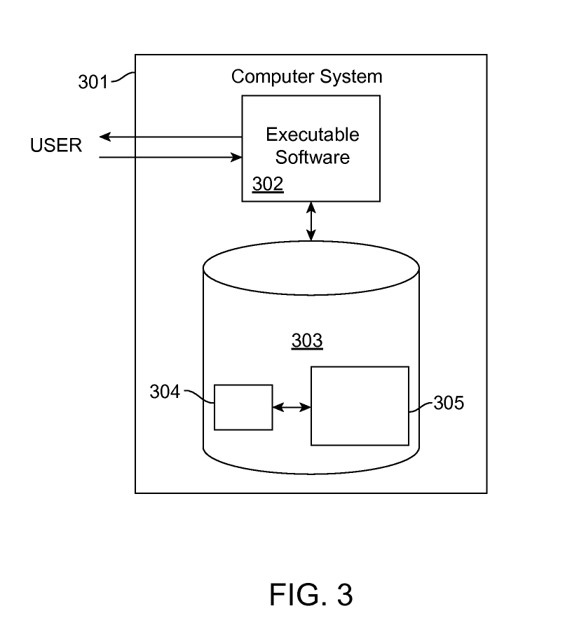

FIG. 3 illustrates hardware of a special purpose computing machine configured to provide a dashboard display of data warehouse information according to an embodiment of the present invention. In particular, computer system 300 comprises a processor 302 that is in electronic communication with a non-transitory computer-readable storage medium 303. This computer-readable storage medium has stored thereon code 305 corresponding to the view engine. Code 304 corresponds to the query engine. Code may be configured to reference data stored in a database of a non-transitory computer-readable storage medium, for example as may be present locally or in a remote database server. Software servers together may form a cluster, or logical network of computer systems programmed with software programs that communicate with each other and work together to process requests.

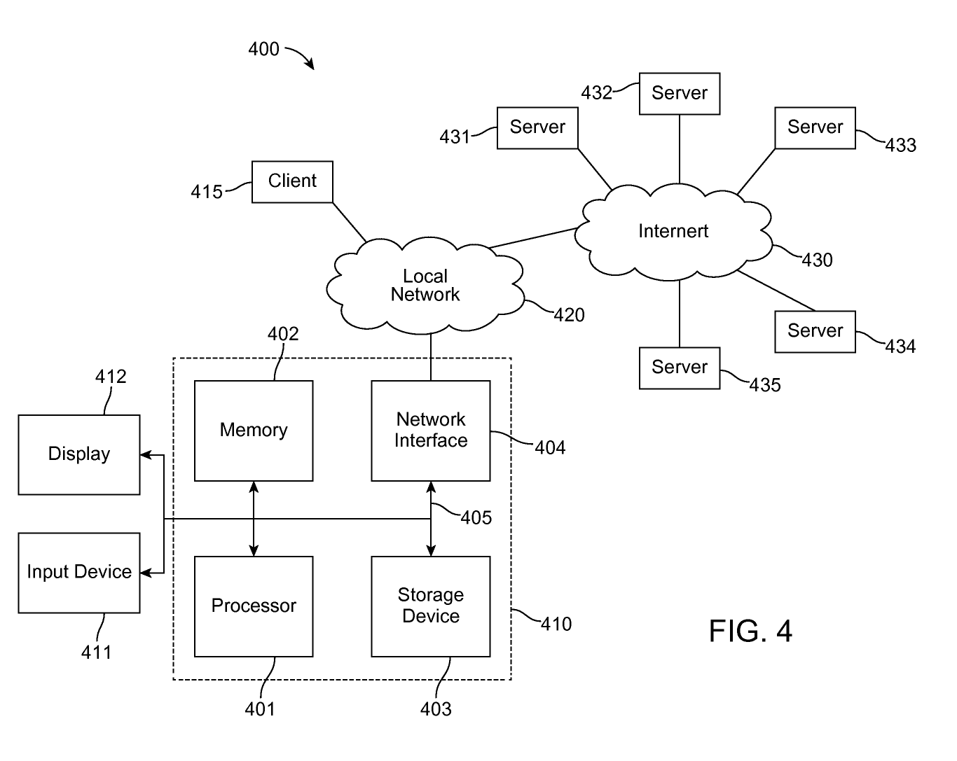

An example computer system 410 is illustrated in FIG. 4. Computer system 410 includes a bus 405 or other communication mechanism for communicating information, and a processor 401 coupled with bus 405 for processing information. Computer system 410 also includes a memory 402 coupled to bus 405 for storing information and instructions to be executed by processor 401, including information and instructions for performing the techniques described above, for example. This memory may also be used for storing variables or other intermediate information during execution of instructions to be executed by processor 401. Possible implementations of this memory may be, but are not limited to, random access memory (RAM), read only memory (ROM), or both. A storage device 403 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 403 may include source code, binary code, or software files for performing the techniques above, for example. Storage device and memory are both examples of computer readable mediums.

Computer system 410 may be coupled via bus 405 to a display 412, such as a cathode ray tube (CRT) or liquid crystal display (LCD), for displaying information to a computer user. An input device 411 such as a keyboard and/or mouse is coupled to bus 405 for communicating information and command selections from the user to processor 401. The combination of these components allows the user to communicate with the system. In some systems, bus 405 may be divided into multiple specialized buses.

Computer system 410 also includes a network interface 404 coupled with bus 405. Network interface 404 may provide two-way data communication between computer system 410 and the local network 420. The network interface 404 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 404 sends and receives electrical, electromagnetic, or optical signals that carry digital data streams representing various types of information.

Computer system 410 can send and receive information, including messages or other interface actions, through the network interface 404 across a local network 420, an Intranet, or the Internet 430. For a local network, computer system 410 may communicate with a plurality of other computer machines, such as server 415. Accordingly, computer system 410 and server computer systems represented by server 415 may form a cloud computing network, which may be programmed with processes described herein. In the Internet example, software components or services may reside on multiple different computer systems 410 or servers 431-435 across the network. The processes described above may be implemented on one or more servers, for example. A server 431 may transmit actions or messages from one component, through Internet 430, local network 420, and network interface 404 to a component on computer system 410. The software components and processes described above may be implemented on any computer system and send and/or receive information across a network, for example.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

1. A computer-implemented method comprising:
causing a view engine to display to a user on a screen, a dashboard comprising a plurality of views of a database query result produced by a query engine, each of the plurality of views including an icon comprising a miniature depiction of a format type of the query result, together with a listing of available views from the database query result, wherein the listing of available views further includes the icon;
causing the view engine to receive an input from a user, wherein the user input comprises selecting a single available view from the listing, wherein the single available view comprises query result information from the database query result;
in response to the input, causing the view engine to create a modified dashboard comprising the single available view; and
causing the view engine to display to the user, the modified dashboard.

2. A method as in claim 1 wherein the user input comprises clicking on the single available view in the listing, and the modified dashboard comprises replacing one of the plurality of views with the single available view.

3. (canceled)

4. A method as in claim 1 wherein the single available view comprises a different format including query result information already present in at least one of the plurality of views.

5. A method as in claim 4 wherein the different format reflects a change between vertical or horizontal orientation.

6. A method as in claim 4 wherein the different format reflects a change between a chart of one format and a chart of a different format.

7. A method as in claim 4 wherein the different view format reflects a change between a chart and a plot.

8. A non-transitory computer readable storage medium embodying a computer program for performing a method, said method comprising:
causing a view engine to display to a user on a screen, a dashboard comprising a plurality of views of a database query result produced by a query engine, each of the plurality of views including an icon comprising a miniature depiction of a format type of the query result, together with a listing of single available views from the database query result, wherein the listing of available views further includes the icon;
causing the view engine to receive an input from a user, wherein the user input comprises selecting an available view from the listing, wherein the single available view comprises query result information from the database query result;
in response to the input, causing the view engine to create a modified dashboard comprising the single available view; and
causing the view engine to display to the user, the modified dashboard.

9. A non-transitory computer readable storage medium as in claim 8 wherein the user input comprises clicking on the single available view in the listing, and the modified dashboard comprises replacing one of the plurality of views with the single available view.

10. (canceled)

11. A non-transitory computer readable storage medium as in claim 8 wherein the single available view comprises a different view format including query result information already present in at least one of the plurality of views.

12. A non-transitory computer readable storage medium as in claim 11 wherein the different format reflects a change between vertical or horizontal orientation.

13. A non-transitory computer readable storage medium as in claim 11 wherein the different format reflects a change between a chart of one typo format and a chart of a different format.

14. A non-transitory computer readable storage medium as in claim 11 wherein the different format reflects a change between a chart and a plot.

15. A computer system comprising:
one or more processors;
a software program, executable on said computer system, the software program configured to:
cause a view engine to display to a user on a screen, a dashboard comprising a plurality of views of a database query result produced by a query engine, each of the plurality of views including an icon comprising a miniature depiction of a format type of the query result, together with a listing of available views from the database query result, wherein the listing of available views further includes the icon;
cause the view engine to receive an input from a user, wherein the user input comprises selecting a single available view from the listing, wherein the single available view comprises query result information from the database query result;
in response to the input, cause the view engine to create a modified dashboard comprising the single available view; and
cause the view engine to display to the user, the modified dashboard.

16. A computer system as in claim 15 wherein the user input comprises clicking on the single available view in the listing, and the modified dashboard comprises replacing one of the plurality of views with the single available view.

17. (canceled)

18. A computer system as in claim 15 wherein the single available view comprises a different view format including query result information already present in at least one of the plurality of views.

19. A computer system as in claim 18 wherein the different format reflects a change between vertical or horizontal orientation.

20. A computer system as in claim 18 wherein the different format reflects a change between one of,
a chart of one format and a chart of a different typo format; and
a chart and a plot.

21. A computer system as in claim 18 wherein the icon comprises a bar chart, a plot, a pie chart, or a table.

22. A method as in claim 1 wherein the icon comprises a bar chart, a plot, a pie chart, or a table.

23. A non-transitory computer readable storage medium as in claim 8 wherein the icon comprises a bar chart, a plot, a pie chart, or a table.
